(19) United States
(12) Patent Application Publication
(10) Pub. No.: US 2007/0024745 A1
(43) Pub. Date: Feb. 1, 2007

(54) Video processing apparatus and video processing method

(75) Inventor: Jung-hwa Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/410,246

(22) Filed: Apr. 25, 2006

(30) Foreign Application Priority Data
Jul. 26, 2005 (KR) 2005-0068031

(51) Int. Cl. H04N 11/20

(52) U.S. Cl. 348/448

(57) ABSTRACT

A video processing apparatus and method are provided where deinterlacing units perform a deinterlacing process for an interlaced video signal, the deinterlacing process corresponding to a video changing rate for time lapse. Downsampling unit performs a downsampling process for the video signal. Video evaluation unit evaluates the video changing rate for time lapse shown by the downsampled video signal, and control unit controls at least one of the deinterlacing units to perform an operation corresponding to the evaluated video changing rate. Accordingly, a video processing apparatus and a video processing method for performing deinterlacing with a small amount of data are provided, thereby improving processing speed and reducing operation load.

### CROSS-REFERENCE TO RELATED APPLICATIONS

This application claims the benefit under 35 U.S.C. § 119(a) of Korean Patent Application Ser. No. 2005-0068031, filed on Jul. 26, 2005, in the Korean Intellectual Property Office, the entire contents of which is hereby incorporated by reference.

### BACKGROUND OF INVENTION

1. Field of Invention

The present invention relates to a video processing apparatus and a video processing method. More particularly, the present invention relates to a video processing apparatus and a video processing method, which evaluates with a small amount of data a video changing rate of an interlaced video signal by downsampling the video signal to perform a deinterlacing process.

2. Description of the Related Art

A video processing apparatus, such as a TV, receives video signal carrying a predetermined video such as digital TV broadcasting, and cable TV broadcasting from broadcasting stations, or receives video signal from a variety of video equipment, such as VCR and DVD player, and performs a video processing on the received video signal to output the video.

The video signal received by such a video processing apparatus carries the information that can be displayed by sequentially scanning a video unit to be displayed, that is, a frame, in the form of plural lines. The video processing apparatus sequentially displays a plurality of frames on the basis of such video signal with the passage of time. However, in the video processing apparatus, there is a limit to the number of frames to be displayed per the unit of time. When the number of frames per the unit of time is less than a predetermined number, it will cause a certain measure of video quality reduction that can be recognized by a human being. In order to solve the problem, therefore, an interlaced scanning method in which video information to be displayed with a frame is divided into halves to be displayed with an odd and even field, which has a double frequency per frame, has been proposed. According to this, although it has a limited number of frames per the unit of time, it has the advantage that video quality reduction is not recognized to the human eye. The video processing apparatus receives such an interlaced video signal to perform an appropriate video process, thereby displaying the video in an interlaced scanning method. For example, CRT (Cathode Ray Tube) is a display device for the video processing apparatus using such an interlaced scanning method.

However, when a sufficient number of frames enough to guarantee video quality can be displayed for the unit of time by the video processing apparatus, it is not necessary to adopt an interlaced scanning method. In other words, even when an interlaced video signal is received by the video processing apparatus, it can add the information divided by two fields to make a frame, thereby displaying all with a so called progressive scanning method. In this case, it is required to have the process of converting an interlaced signal into a progressive signal, so called, deinterlacing. For instance, a video processing apparatus such as digital TV can receive an interlaced signal to perform a deinterlacing process, thereby displaying the video with a progressive method.

FIG. 1 is a block diagram schematically illustrating a configuration of a conventional video processing apparatus for performing a deinterlacing process. As illustrated in FIG. 1, a video processing apparatus 10 includes a tuner 11, a decoder 12, a downsampling unit 13, a video evaluation unit 14, a control unit 15, a deinterlacing unit 16, a scaler 17, and a display unit 18. For broadcasting video signal, the tuner 11 receives the video signal of the frequency band corresponding to a predetermined channel that is selected by the user. The decoder 12 decodes the received signal on the basis of a prescribed standard, and retrieves video information such as brightness, color, and the like.

The deinterlacing unit 16 performs a deinterlacing process on the interlaced signal received from the decoder 12, and converts it into a progressive signal. The deinterlacing unit 16 can perform a deinterlacing process in various ways; for instance, it may include a weaving unit 16a for performing a weaving process, and a blending unit 16b for performing a blending process. On the other hand, the video evaluation unit 14 evaluates the characteristic of video, that is, whether it is static or dynamic video, or the like on the basis of the decoded video information. The control unit 15 determines whether it will perform a weaving or blending process according to the characteristic of video so as to instruct the deinterlacing unit 16 what type of deinterlacing method will be applied.

The scaler 17 performs a predetermined video process for displaying the deinterlaced progressive signal to an appropriate size and position. The display unit 18 displays video on the basis of the signal processed by the scaler 17. On the other hand, the downsampling unit 13 performs a downsampling process for reducing the data rate of signal or the amount of data to output while maintaining the interlaced method.

In other words, according to a conventional video processing apparatus 10, it is required to understand video characteristic such as video movement, which is carried by the signal, in advance, so as to apply various deinterlacing methods to an interlaced signal. However, there is a problem that a heavy load is carried in such a video process for understanding video characteristic. In particular, in case where an HD (high definition) signal having a large amount of data such as digital TV should be processed, the amount of data being processed to understand the video characteristic for deinterlacing would be increased, and it has created the concern of a heavy burden on the operation of the video processing apparatus 10.

### SUMMARY OF THE INVENTION

Accordingly, it is an aspect of the present invention to provide a video processing apparatus and a video processing method for performing deinterlacing with a small amount of data, thereby improving processing speed and reducing operation load.

Additional features of exemplary embodiments of the present invention will be set forth in the description which follows, and in part will be apparent from the description, or may be learned by practice of the invention.

The foregoing and/or other exemplary aspects of the present invention may be achieved by providing a video processing apparatus comprising a plurality of deinterlacing units performing a deinterlacing process for an interlaced video signal and corresponding to a video changing rate for time lapse, a downsampling unit for downsampling process a video signal a video evaluation unit evaluating the video changing rate for time lapse shown by the downsampled video signal, and a control unit controlling one of the plurality of deinterlacing units to perform an operation corresponding to the evaluated video changing rate.

According to an aspect of the present invention, the plurality of deinterlacing units comprise a first deinterlacing unit for adding two consecutive fields for the interlaced video signal, and the control unit enables an operation of the first deinterlacing unit when it is judged that the evaluated video changing rate is less than a predetermined value.

According to an aspect of the present invention, the plurality of deinterlacing units comprise a second deinterlacing unit for blending two consecutive fields for the interlaced video signal, and the control unit enables an operation of the second deinterlacing unit when it is judged that the evaluated video changing rate is larger than a predetermined value.

The foregoing and/or another exemplary aspects of the present invention can be achieved by providing a video processing method where a downsampling process for an interlaced video signal is performed, a video changing rate for time lapse shown by the downsampled video signal is evaluated, and a deinterlacing process corresponding to the evaluated video changing rate is performed.

According to an aspect of the present invention, the performing of the deinterlacing process comprises adding two consecutive fields for the interlaced video signal when it is judged that the evaluated video changing rate is less than a predetermined value.

According to an aspect of the present invention, the performing of the deinterlacing process comprises blending two consecutive fields for the interlaced video signal when it is judged that the evaluated video changing rate is larger than a predetermined value.

It is to be understood that both the foregoing general description and the following detailed description are exemplary and explanatory and are intended to provide further explanation of certain exemplary implementations of the present invention.

### BRIEF DESCRIPTION OF THE DRAWINGS

The above and/or other exemplary aspects and advantages of the prevent invention will become apparent and more readily appreciated from the following description of the exemplary embodiments, taken in conjunction with the accompany drawings, in which like reference numerals will be understood to refer to like parts, components and structures, where:

FIG. 1 is a block diagram schematically illustrating a configuration of a conventional video processing apparatus for performing a deinterlacing process;

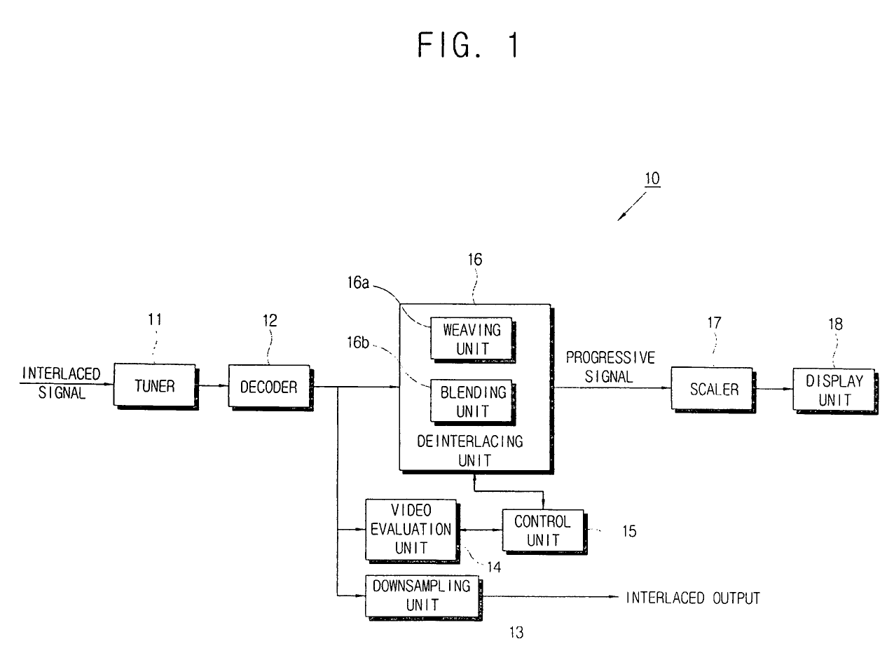

FIG. 2 is a block diagram schematically illustrating a configuration of a video processing apparatus according to an exemplary embodiment of the present invention; and

FIG. 3 is a flow chart schematically illustrating an operation of a video processing apparatus according to an exemplary embodiment of the present invention.

### DETAILED DESCRIPTION OF EXEMPLARY EMBODIMENTS

Reference will now be made in detail to certain exemplary embodiments of the present invention, examples of which are illustrated in the accompanying drawings, wherein as noted above like reference numerals refer to like elements throughout. The exemplary embodiments are described below so as to explain certain non-limiting features of the present invention with reference to the figures.

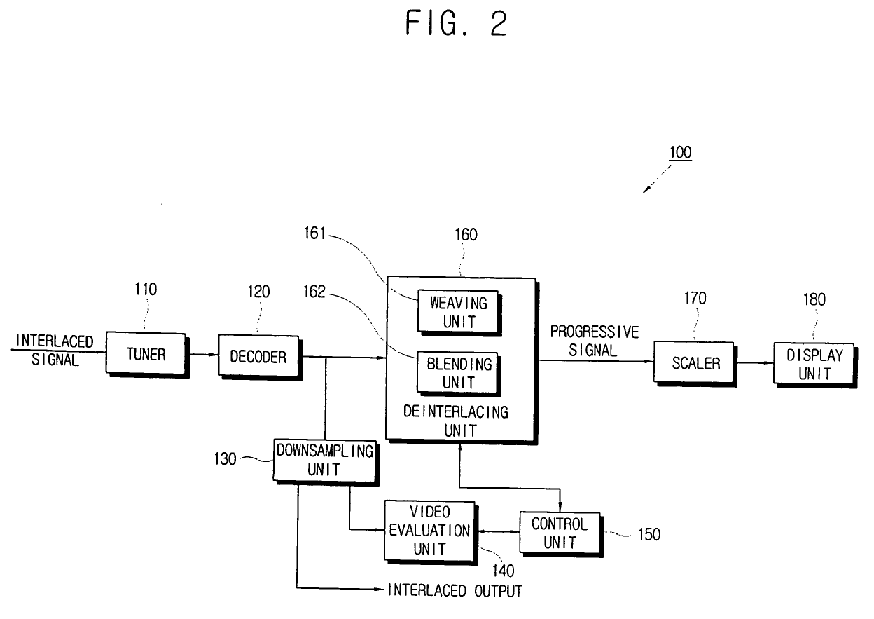

FIG. 2 is a block diagram schematically illustrating a configuration of a video processing apparatus 100 according to an exemplary embodiment of the present invention. A video processing apparatus 100 according to an exemplary implementation of the present invention can be realized by digital TV, or the like, and it receives the video signal carrying a predetermined video such as digital TV broadcasting, and cable TV broadcasting from broadcasting stations, and performs a video process on the received video signal to display a video. The video processing apparatus 100 receives an interlaced signal as video signal, and performs a deinterlacing process for the received signal to convert it into a progressive signal. The video processing apparatus 100 may achieve an improved processing speed and reduced operating load due to a reduction in the amount of data being processed for performing a deinterlacing process.

The video processing apparatus 100, as illustrated in FIG. 2, includes a tuner 110, a decoder 120, a downsampling unit 130, a video evaluation unit 140, a control unit 150, a deinterlacing unit 160, a scaler 170, and a display unit 180. For broadcasting signal, the tuner 110 receives the video signal of the frequency band corresponding to a predetermined channel that is selected by the user. The video signal received by the tuner 110 according to an exemplary implementation of the present invention may be HDTV (high definition television) signal as an interlaced signal, for example. The HDTV signal can have a resolution of 1920×1080 or 1280×720 (pixel×lines) with an aspect ratio of 16:9, and can be interlaced at 50 or 60 fields per second. The decoder 120 decodes the received video signal according to a prescribed standard, and retrieves video information such as luminance, chrominance, horizontal sync, vertical sync, and the like.

The deinterlacing unit 160 performs a deinterlacing process on the interlaced signal that is received from the decoder 120, and converts it to a progressive signal to output. The deinterlacing unit 160 according to an exemplary embodiment includes a weaving unit 161 and a blending unit 162. The weaving unit 161 performs the process of adding two consecutive fields of video signal, a so called weaving. Such a weaving process may be appropriate when video between the two fields is not changed; as a result, its temporal resolution is reduced by half, but its vertical resolution is maintained as it is. The blending unit 162 performs the process of blending or averaging two consecutive fields to be displayed as a frame, a so called blending. According to this blending process, any one of two images is overlapped over the other image, so an artifact such as mouse teeth may not be formed, but an artifact such as so called ghosting may be created. Accordingly, vertical resolution as well as temporal resolution can be reduced, and the level of video details can be lowered to bring an effect of smoothing video.

The downsampling unit 130 is arranged at an output end of the decoder 120 to perform a downsampling process for lowering the data rate or reducing the amount of data for the received signal. The signal outputted from the downsampling unit 130 is used for video characteristic evaluation and interlace output.

The video evaluation unit 140 is arranged at an output end of the decoder 120 to determine the characteristic of video, that is, whether it is a static or dynamic video, or the like on the basis of the decoded video information for the received signal. The video evaluation unit 140 evaluates the video changing rate of two consecutive fields for the received signal to determine whether the video is static or dynamic video. The video changing rate of two consecutive fields in this embodiment is an example of video changing rate for time lapse in the present invention.

The control unit 150 determines for the deinterlacing unit 160 what type of deinterlacing process will be performed between weaving and blending according to the characteristic of video evaluated by the video evaluation unit 140. The control unit 150 receives the video changing rate of two consecutive fields from the video evaluation unit 140, and then it is judged as static video when the change rate is less than a predetermined value, and it is judged as dynamic video when the change rate is larger than a predetermined value. The control unit 150 controls the deinterlacing unit 160 for enabling an operation of the weaving unit 161 with respect to the signal output by the decoder 120 when it is judged as static video. The control unit 150 controls the deinterlacing unit 160 for enabling an operation of the blending unit 162 with respect to the signal output by the decoder 120 when it is judged as dynamic video. Such control operation of the control unit 150 is called selective blending, smart blending, or motion adaptive blending. Accordingly, temporal resolution is reduced by half, but vertical resolution is maintained, so it has an advantage of reducing artifact when compared with each case of weaving or blending.

According to an exemplary embodiment, control unit 150 may be realized by a computer program that is implemented by a microprocessor such as a CPU. In an exemplary implementation, the computer program can be stored in a memory such as ROM. The computer program is programmed by an adequate language for performing a control operation of the control unit 150.

The scaler 170 is arranged at an output end of the deinterlacing unit 160 to perform a predetermined video process for displaying a deinterlaced progressive signal to an appropriate size and position. The display unit 180 displays a video on the basis of the signal that is processed by the scaler 170.

As describe above, according to exemplary implementations of the present invention, video processing apparatus performs a deinterlacing process with a small amount of data by evaluating the characteristic of video for a signal having a reduced amount of data by downsampling, not by evaluating the characteristic of video for a deinterlaced signal itself, thereby improving processing speed and reducing operating load. For example, by using a downsampling unit that is provided in the apparatus, the above effect can be attained without additional cost.

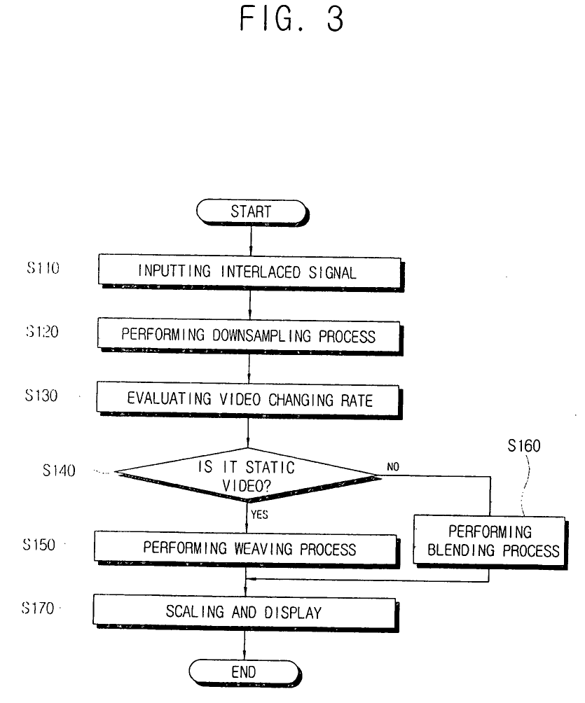

FIG. 3 is a flow chart schematically illustrating an operation of a video processing apparatus 100 according to an exemplary embodiment of the present invention. When an interlaced signal is received (S110), the video processing apparatus 100 performs a downsampling process for the received signal (S120). The video processing apparatus 100 evaluates the change rate of video for the downsampled signal (S130). When the evaluated video is judged as static video (S140), the video processing apparatus 100 performs a deinterlacing process with a weaving method (S150). When the evaluated video is judged as dynamic video (S140), the video processing apparatus 100 performs a deinterlacing process with a blending method (S160). The video processing apparatus 100 performs a scaling process for the deinterlaced signal to display (S170).

As shown above, although certain exemplary embodiments of the present invention have been described in detail, the present invention is not limited to these embodiments, and various modifications can be made within the scope and spirit of the present invention.

As described above, a video processing apparatus and a video processing method may evaluate with a small amount of data a video changing rate of an interlaced video signal by downsampling the video signal to perform a deinterlacing process, thereby improving processing speed and reducing operating load.

Although certain exemplary embodiments of the present invention have been shown and described, it will be appreciated by those skilled in the art that various changes and modifications are possible without departing from the principles and spirit of the invention, the scope of which is defined in the appended claims and their equivalents.

What is claimed is:

1. A video processing apparatus comprising:
at least a first deinterlacing unit for deinterlacing an interlaced video signal, the deinterlacing corresponding to a video changing rate for time lapse;
a downsampling unit for downsampling the video signal;
a video evaluation unit for evaluating the video changing rate for time lapse shown by the downsampled video signal; and
a control unit controlling at least the first deinterlacing unit to deinterlace the video signal in accordance with the evaluated video changing rate.

2. The video processing apparatus according to claim 1, wherein the first deinterlacing unit is configured to add two consecutive fields for the interlaced video signal, and
the control unit enables an operation of the first deinterlacing unit when the evaluated video changing rate is less than a reference value.

3. The video processing apparatus according to claim 2, further comprising a second deinterlacing unit configured to blend two consecutive fields for the interlaced video signal,
wherein the control unit enables an operation of the second deinterlacing unit when the evaluated video changing rate is greater than the reference value.

4. The video processing apparatus according to claim 1, further comprising a second deinterlacing unit configured to blend two consecutive fields for the interlaced video signal,
wherein the control unit enables an operation of the second deinterlacing unit when the evaluated video changing rate is greater than a reference value.

5. A video processing method comprising:
downsampling an interlaced video signal;
evaluating a video changing rate for time lapse shown by the downsampled video signal; and
performing a deinterlacing process in accordance with the evaluated video changing rate.

6. The video processing method according to claim 5, wherein the performing of the deinterlacing process comprises adding two consecutive fields for the interlaced video signal when the evaluated video changing rate is less than a reference value.

7. The video processing method according to claim 6, wherein the performing of the deinterlacing process comprises blending two consecutive fields for the interlaced video signal when the evaluated video changing rate is greater than the reference value.

8. The video processing method according to claim 5, wherein the performing of the deinterlacing process comprises blending two consecutive fields for the interlaced video signal when the evaluated video changing rate is greater than a reference value.
